(19) United States
(12) Patent Application Publication
(10) Pub. No.: US 2014/0317576 A1
(43) Pub. Date: Oct. 23, 2014

(54) METHOD AND SYSTEM FOR RESPONDING TO USER'S SELECTION GESTURE OF OBJECT DISPLAYED IN THREE DIMENSIONS

(71) Applicants: Jianping Song, Beijing (CN); Lin Du, Beijing (CN); Wenjuan Song, Beijing (CN)

(72) Inventors: Jianping Song, Beijing (CN); Lin Du, Beijing (CN); Wenjuan Song, Beijing (CN)

(73) Assignee: THOMSON LICENSING, Issy de Moulineaux (FR)

(21) Appl. No.: 14/362,182

(22) PCT Filed: Dec. 6, 2011
(86) PCT No.: PCT/CN2011/083552

§ 371 Date: Jun. 2, 2014

(51) Int. Cl. G06F 3/0481; G06F 3/01; G06F 3/0484

(52) U.S. Cl. CPC G06F 3/04815; G06F 3/04842; G06F 3/017; G06F 3/013
USPC 715/852

(57) ABSTRACT

The present invention relates to a method for responding to a users selection gesture of an object displayed in three dimensions. The method comprises comprising displaying at least one object using a display, detecting a users selection gesture captured using an image capturing device, and based on the image capturing devices output, determining whether an object among said at least one objects is selected by said user as a function of the eye position of the user and of the distance between the users gesture and the display.

### FIELD OF THE INVENTION

The present invention relates to method and system for responding to a clicking operation by a user in a 3D system. More particularly, the present invention relates to fault-tolerant method and system for responding to a clicking operation by a user in a 3D system using a value of a response probability.

### BACKGROUND OF THE INVENTION

As late as the early 1990's, a user interacted with most computers through character user interfaces (CUIs), such as Microsoft's MS-DOS™ operating system and any of the many variations of UNIX. Text-based interfaces in order to provide complete functionality often contained cryptic commands and options that were far from intuitive to the non-experienced users. Keyboard was the most important, if not the unique, device that the user issued commands to computers.

Most current computer systems use two-dimensional graphical user interfaces. These graphical user interfaces (GUIs) usually use windows to manage information and use buttons to enter user's inputs. This new paradigm along with the introduction of the mouse revolutionized how people used computers. The user no longer had to remember arcane keywords and commands.

Although the graphical user interfaces is more intuitive and convenient than character user interfaces, the user is still bound to use devices such as the keyboard and the mouse. Touch screen is a key device that enables the user to interact directly with what is displayed without requiring any intermediate device that would need to be held in the hand. However, the user still needs to touch the device, which limits the user's activity.

Recently, enhancing the perceptual reality has become one of the major forces that drive the revolution of next generation displays. These displays use three-dimensional (3D) graphical user interfaces to provide more intuitive interaction. A lot of conceptual 3D input devices are accordingly designed so that the user can conveniently communicate with the computers. However, because of the complexity of 3D space, these 3D input devices usually are less convenient than traditional 2D input devices such as a mouse. Moreover, the fact that the user is still bound to use some input devices greatly reduces the nature of interaction.

Note that speech and gesture are the most commonly used means of communication among humans. With the development of 3D user interfaces, e.g., virtual reality and augmented reality, there is a real need for speech and gesture recognition systems that enable users to conveniently and naturally interact with computers. While speech recognition systems are finding their way into computers, the gesture recognition systems meet great difficulty in providing robust, accurate and real-time operation for typical home or business users when users don't depend on any devices except for their hands. In 2D graphical user interfaces, clicking command may be the most important operation although it can be conveniently implemented by a simple mouse device. Unfortunately, it may be the most difficult operation in gesture recognition systems because it is difficult to accurately obtain the spatial position of the fingers with respect to the 3D user interface the user is watching.

In a 3D user interface with gesture recognition system, it is difficult to accurately obtain the spatial position of the fingers with respect to the 3D position of a button the user is watching. Therefore, it is difficult to implement the clicking operation that may be the most important operation in traditional computers. This invention presents a method and a system to resolve the problem.

As related art, GB2462709A discloses a method for determining compound gesture input.

### SUMMARY OF THE INVENTION

According to an aspect of the present invention, there is provided a method for responding to a user's selection gesture of an object displayed in three dimensions. The method comprises displaying at least one object using a display device, detecting a user's selection gesture captured using an image capturing device, and determining based on the image capturing device's output whether an object among said at least one objects is selected by said user as a function of the eye position of the user and of the distance between the user's gesture and the display device.

According to another aspect of the present invention, there is provided a system for responding to a user's selection gesture of an object displayed in three dimensions. The system comprises means for displaying at least one object using a display device, means for detecting a user's selection gesture captured using an image capturing device, and means for determining based on the image capturing device's output whether an object among said at least one objects is selected by said user as a function of the eye position of the user and of the distance between the user's gesture and the display device.

### BRIEF DESCRIPTION OF DRAWINGS

These and other aspects, features and advantages of the present invention will become apparent from the following description in connection with the accompanying drawings in which:

FIG. 1 is an exemplary diagram showing a basic computer terminal embodiment of an interaction system in accordance with the invention;

FIG. 2 is an exemplary diagram showing an example of a set of gestures that are used in the illustrative interaction system of FIG. 1;

FIG. 3 is an exemplary diagram showing a geometry model of binocular vision;

FIG. 4 is an exemplary diagram showing a geometry representation of the perspective projection of a scene point on the two camera images;

FIG. 5 is an exemplary diagram showing the relation between the screen coordinate system and the 3D real world coordinate system;

FIG. 6 is an exemplary diagram showing how to calculate the 3D real world coordinate by the screen coordinate and the position of eyes;

FIG. 7 is a flow chart showing a method for responding to a user's clicking operation in the 3D real world coordinate system according to an embodiment of the present invention.

FIG. 8 is an exemplary block diagram of a computer device according to an embodiment of the present invention.

### DETAIL DESCRIPTION OF PREFERRED EMBODIMENTS

In the following description, various aspects of an embodiment of the present invention will be described. For the purpose of explanation, specific configurations and details are set forth in order to provide a thorough understanding. However, it will also be apparent to one skilled in the art that the present invention may be practiced without the specific details present herein.

This embodiment discloses a method for responding to a clicking gesture by a user in a 3D system. The method defines a probability value that a displayed button should respond the user's clicking gesture. The probability value is computed according to the position of the fingers when clicking is triggered, the position of the button dependent on the positions of user's eyes, and the size of the button. The button with the highest clicking probability will be activated in response to the user's clicking operation.

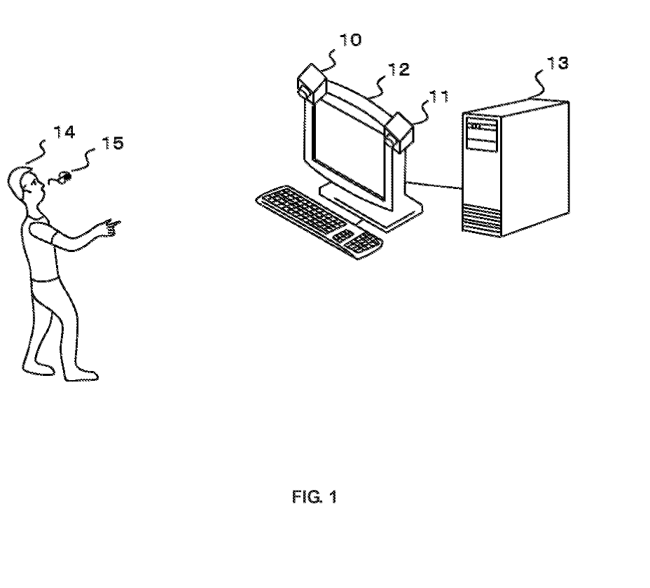

FIG. 1 illustrates the basic configuration of the computer interaction system according to an embodiment of the present invention. Two cameras 10 and 11 are respectively located on each side of the upper surface of monitor 12 (for example a TV of 60 inch diagonal screen size). The cameras are connected to PC computer 13 (it may be integrated into the monitor). The user 14 watches the stereo content displayed on the monitor 12 by wearing a pair of red-blue glasses 15, shutter glasses or other kinds of glasses, or without wearing any glasses if the monitor 12 is an auto stereoscopic display.

In operation, a user 14 controls one or more applications running on the computer 13 by gesturing within a three-dimensional field of view of the cameras 10 and 11. The gestures are captured using the cameras 10 and 11 and converted into a video signal. The computer 13 then processes the video signal using any software programmed in order to detect and identify the particular hand gestures made by the user 14. The applications respond to the control signals and display the result on the monitor 12.

The system can run readily on a standard home or business computer equipped with inexpensive cameras and is, therefore, more accessible to most users than other known systems. Furthermore, the system can be used with any type of computer applications that require 3D spatial interactions. Example applications include 3D games and 3D TV.

Although FIG. 1 illustrates the operation of interaction system in conjunction with a conventional stand-alone computer 13, the system can of course be utilized with other types of information processing devices, such as laptops, workstations, tablets, televisions, set-top boxes, etc. The term “computer” as used herein is intended to include these and other processor-based devices.

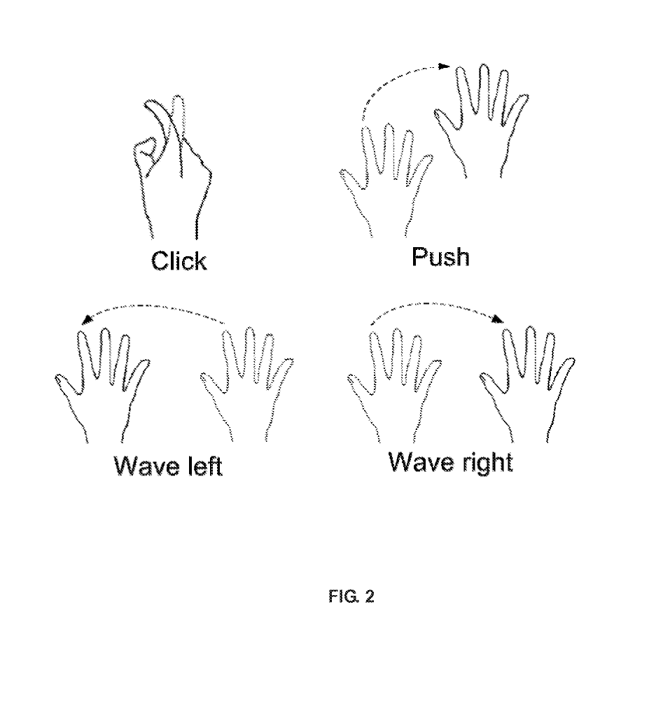

FIG. 2 shows a set of gestures recognized by the interaction system in the illustrative embodiment. The system utilizes recognition techniques (for example, those based on boundary analysis of the hand) and tracing techniques to identify the gesture. The recognized gestures may be mapped into application commands such as “click”, “close door”, “scroll left”, “turn right”, etc. The gestures such as push, wave left, wave right are easy to recognize. The gesture click is also easy to recognize but the accurate position of the clicking point with respect to the 3D user interface the user is watching is relatively difficult to identify.

In theory, in the two-camera system, given the focal length of the cameras and the distance between the two cameras, the position of any spatial point can be obtained by the positions of the image of the point on the two cameras. However, for the same object in the scene, the user may think the position of the object is different in space if the user watches the stereo content in a different position. In FIG. 2, the gestures are illustrated using right hand, but we can use left hand or other part of the body instead.

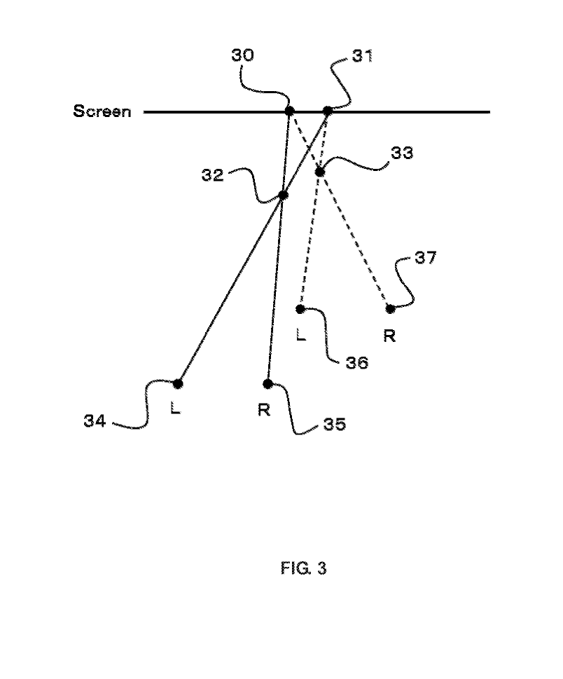

With reference to FIG. 3, the geometry model of binocular vision is shown using the left and right views on a screen plane for a distant point. As shown in FIG. 3, point 31 and 30 are the image points of the same scene point in the left view and right view, respectively. In other words, point 31 and 30 are the projection points of a 3D point in the scene onto the left and right screen plane. When the user stands in the position where point 34 and 35 are the left and right eye, respectively, the user will think that the scene point is at the position of point 32, although the left and right eyes see it from point 31 and 30, respectively. When the user stands in another position where point 36 and 37 are the left and right eye, respectively, he will think that the scene point is at the position of point 33. Therefore, for the same scene object, the user will find that its spatial position has changed with the change of his position. When the user tries to “click” the object using his hand, he will click on a different spatial position. As a result, the gesture recognition system will think the user is clicking at a different position. The computer will recognize the user is clicking on different items of the applications and thus will issue incorrect commands to the applications.

A common method to resolve the issue is that the system displays a “virtual hand” to tell the user where the system thinks the user's hand is. Obviously the virtual hand will spoil the naturalness of the bare hand interaction.

Another common method to resolve the issue is that each time the user changes his position, he should ask the gesture recognition system to recalibrate its coordinate system so that the system can map the user's clicking point to the interface objects correctly. This is sometimes very inconvenient. In many cases the user just slightly changes the body's pose without changing his position, and in more cases the user just change the position of his head, and he is not aware of the change.

In these cases it is unrealistic to recalibrate the coordinate system each time the user's eyes' position change.

In addition, even if the user doesn't change his eyes' position, he often finds that he cannot always click on the object exactly, especially when he is clicking on relatively small objects. The reason is that clicking in space is difficult. The user may not be dexterous enough for precisely controlling the direction and speed of his index finger, his hand may shake, or his fingers or hands may hide the object. The accuracy of the gesture recognition system also impacts the correctness of clicking commands. For example, the finger may move too fast to be recognized accurately by the camera tracking system, especially when the user is far away from the camera.

Therefore, there is a strong need that the interaction system is fault-tolerant so that the small change of the position of user's eyes and the inaccuracy of the gesture recognition system won't frequently incur incorrect commands. That is, even if the system detects that the user doesn't click on any object, in some cases it is reasonable for the system to determine activation of an object in response to the user's clicking gesture. Obviously, the closer the clicking point is to an object, the higher the probability that the object responds to the clicking (i.e. activation) gesture.

In addition, it is obvious that the accuracy of the gesture recognition system is impacted greatly by the distance of the user to the cameras. If the user is far away from the cameras, the system is apt to incorrectly recognize the clicking point. On the other hand, the size of the button or more generally the object to be activated on the screen also has a great impact on the correctness. A larger object is easier to click by users.

Therefore, the determination of the degree of response of an object is based on the distance of the clicking point to the camera, the distance of the clicking point to the object and the size of the object.

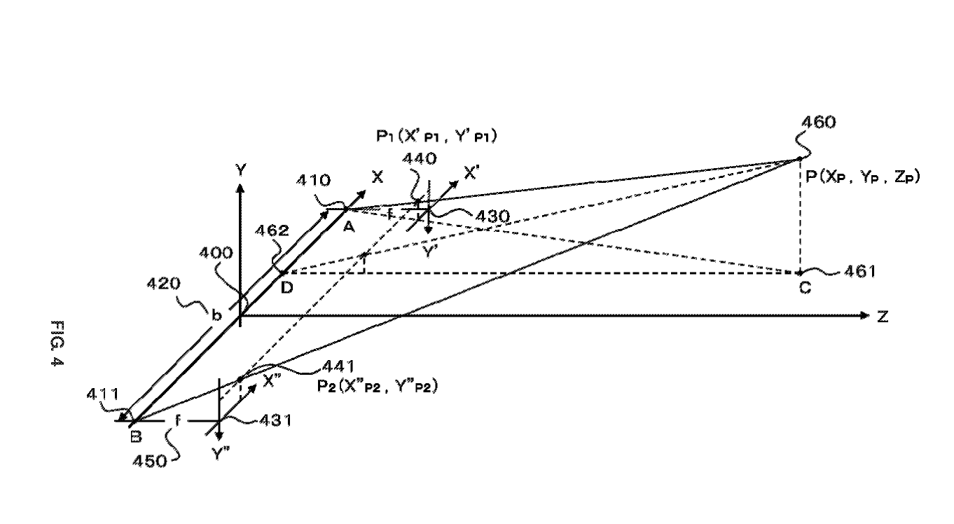

FIG. 4 illustrates the relationship between the camera 2D image coordinate system (430 and 431) and the 3D real world coordinate system 400. More specifically, the origin of the 3D real world coordinate system 400 is defined at the center of the line between the left camera nodal point A 410 and the right camera nodal point B 411. The perspective projection of a 3D scene point P(X_{P}, Y_{P}, Z_{P}) 460 on the left image and the right image is denoted by points P₁(X′_{P1}, Y′_{P1}) 440 and P₂(X″_{P2}, Y″_{P2}) 441, respectively. The disparities of point P₁ and P₂ are defined as

d_{XP}=X″_{P2}−X′_{P1} Eq. (1)

and

d_{YP}=Y″_{P2}−Y′_{P1} Eq. (2)

In practice, the cameras are arranged in such a way that the value of one of the disparities is always considered being zero. Without loss of the generality, in the present invention, the two cameras 10 and 11 in FIG. 1 are aligned horizontally. Therefore, d_{YP}=0. The cameras 10 and 11 are assumed to be identical and therefore have the same focal length f 450. The distance between the left and right images is the baseline b 420 of the two cameras.

The perspective projection of the 3D scene point P(X_{P}, Y_{P}, Z_{P}) 460 on the XZ plane and X axis is denoted by points

C(X_{P}, 0, Z_{P}) 461 and D(X_{P}, 0, 0) 462, respectively. Observe FIG. 4, the distance between point P₁ and P₂ is b−dₓₚ. Observe triangle PAB, we can conclude that

$$\frac{b - {d}_{XP}}{b} = \frac{{PP}_{1}}{PA} \qquad Eq . ( 3 )$$

Observe triangle PAC, we can conclude that

$$\frac{{Y}_{P 1}^{′}}{{Y}_{P}} = \frac{{P}_{1} A}{PA} = 1 - \frac{{PP}_{1}}{PA} \qquad Eq . ( 4 )$$

Observe triangle PDC, we can conclude that

$$\frac{{Y}_{P 1}^{′}}{{Y}_{P}} = \frac{f}{{Z}_{P}} \qquad Eq . ( 5 )$$

Observe triangle ACD, we can conclude that

$$\frac{\frac{b}{2} - {X}_{P} + {X}_{P 1}^{′}}{\frac{b}{2} - {X}_{P}} = \frac{{Z}_{P} - f}{{Z}_{P}} \qquad Eq . ( 6 )$$

According to Eq. (3) and (4), we have

$$\frac{b - {d}_{XP}}{b} = 1 - \frac{{Y}_{P 1}^{′}}{{Y}_{P}} \qquad Eq . ( 7 )$$

Therefore, we have

$${Y}_{P} = \frac{b}{{d}_{XP}} {Y}_{P 1}^{′} \qquad Eq . ( 8 )$$

According to Eq. (5) and (8), we have

$${Z}_{P} = \frac{b}{{d}_{XP}} f \qquad Eq . ( 9 )$$

According to Eq. (6) and (9), we have

$${X}_{P} = \frac{b}{2} + \frac{b}{{d}_{XP}} {X}_{P 1}^{′} \qquad Eq . ( 10 )$$

From Eq. (8), (9), and (10), the 3D real world coordinates (X_{P}, Y_{P}, Z_{P}) of a scene point P can be calculated according to the 2D image coordinates of the scene point in the left and right images.

The distance of the clicking point to the camera is the value of Z coordinates of the clicking point in the 3D real world coordinate system, which can be calculated by the 2D image coordinates of the clicking point in the left and right images.

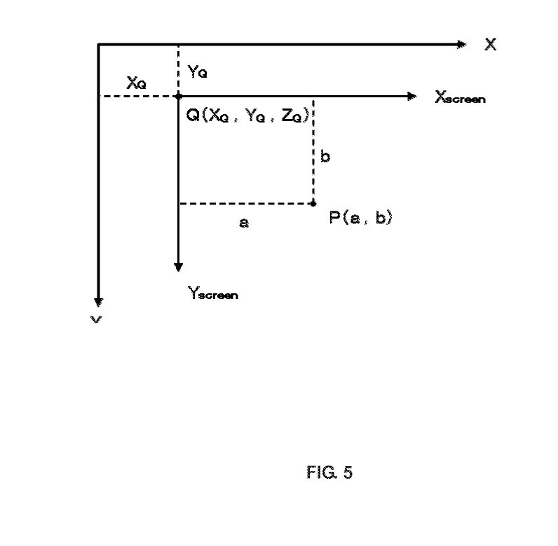

FIG. 5 illustrates the relation between the screen coordinate system and the 3D real world coordinate system to explain how to translate a coordinate of the screen system and a coordinate of the 3D real world coordinate system. Suppose that the coordinate of the origin point Q of the screen coordinate system in the 3D real world coordinate system is (X_{Q}, Y_{Q}, Z_{Q}) (which is known to the system). A screen point P has the screen coordinate (a, b). Then the coordinate of point P in the 3D real world coordinate system is P(X_{Q+a}, Y_{Q+b}, Z_{Q}). Therefore, given a screen coordinate, we can translate it to the 3D real world coordinate.

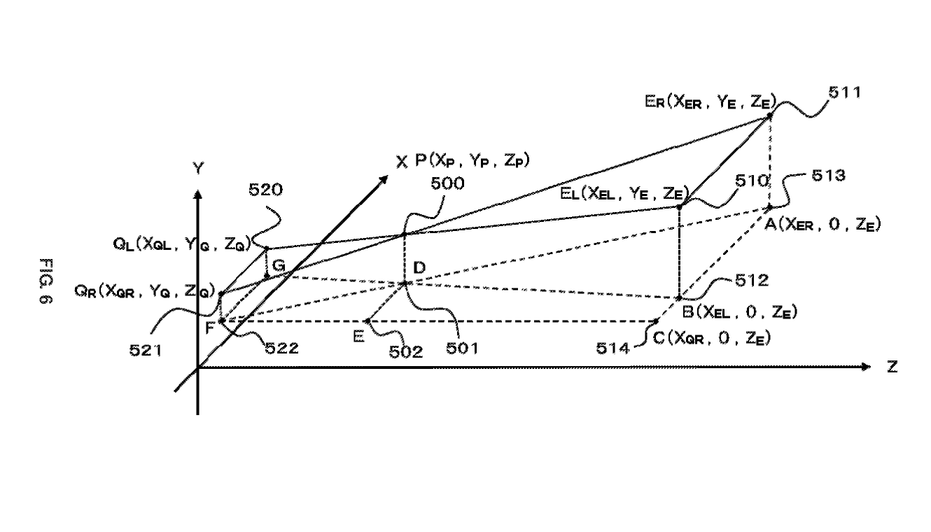

Next, FIG. 6 is illustrated to explain how to calculate the 3D real world coordinate by the screen coordinate and the position of eyes. In FIG. 6, all the given coordinates are 3D real world coordinate. It is reasonable to suppose that the Y and Z coordinates of a user's left eye and right eye are the same, respectively. The coordinate of the user's left eye E_{L}(X_{EL}, Y_{E}, Z_{E}) 510 and right eye E_{R}(X_{ER}, Y_{E}, Z_{E}) 511 can be calculated by the image coordinate of the eyes in the left and right camera images, according to Equation (8), (9) and (10). The coordinate of an object in the left view Q_{L}(X_{QL}, Y_{Q}, Z_{Q}) 520 and right view Q_{R}(X_{QR}, Y_{Q}, Z_{Q}) 521 can be calculated by their screen coordinates, as described above. The user will feel that the object is at the position P(X_{P}, Y_{P}, Z_{P}) 500.

Observe triangle ABD and FGD, we can conclude that

$$\frac{AD}{FD} = \frac{AB}{FG} = \frac{{X}_{ER} - {X}_{EL}}{{X}_{QL} - {X}_{QR}} \qquad Eq . ( 11 )$$

Observe triangle FDE and FAC, we can conclude that

$$\frac{AD}{FD} = \frac{CE}{FE} = \frac{{Z}_{E} - {Z}_{P}}{{Z}_{P} - {Z}_{Q}} \qquad Eq . ( 12 )$$

According to Eq. (11) and (12), we have

$$\frac{{X}_{ER} - {X}_{EL}}{{X}_{QL} - {X}_{QR}} = \frac{{Z}_{E} - {Z}_{P}}{{Z}_{P} - {Z}_{Q}} \\ Therefore \\ {Z}_{P} = \frac{( {X}_{QL} - {X}_{QR} ) {Z}_{E} + ( {X}_{ER} - {X}_{EL} ) {Z}_{Q}}{( {X}_{ER} - {X}_{EL} ) + ( {X}_{QL} - {X}_{QR} )} \qquad Eq . ( 13 )$$

Observe triangle FDE and FAC, we have

$$\begin{matrix}\frac{DE}{AC} = \frac{FD}{FA} \\ Therefore & Eq . ( 14 ) \\ \frac{DE}{AC - DE} = \frac{FD}{FA - FD} = \frac{FD}{AD} & Eq . ( 15 )\end{matrix}$$

According to Eq. (11) and (15), we have

$$\frac{DE}{AC - DE} = \frac{FG}{AB}$$

$$That is , \\ \frac{{X}_{P} - {X}_{QR}}{( {X}_{ER} - {X}_{QR} ) - ( {X}_{P} - {X}_{QR} )} = \frac{{X}_{QL} - {X}_{QR}}{{X}_{ER} - {X}_{EL}}$$

Therefore, we have

$${X}_{P} = \frac{{X}_{QL} {X}_{ER} - {X}_{QR} {X}_{EL}}{( {X}_{ER} - {X}_{EL} ) + ( {X}_{QL} - {X}_{QR} )} \qquad Eq . ( 16 )$$

Similarly, observe trapezium Q_{R}FDP and Q_{R}FAE_{R}, we have

$$\begin{matrix}\frac{PD - {Q}_{R} F}{{E}_{R} A - {Q}_{R} F} = \frac{FD}{FA} \\ Threfore , & Eq . ( 17 ) \\ \frac{PD - {Q}_{R} F}{( {E}_{R} A - {Q}_{R} F ) - ( PD - {Q}_{R} F )} = \frac{FD}{FA - FD} = \frac{FD}{AD} & Eq . ( 18 )\end{matrix}$$

According to Eq. (11) and (18). we have

$$\frac{PD - {Q}_{R} F}{{E}_{R} A - PD} = \frac{FG}{AB} \\ That is , \\ \frac{{Y}_{P} - {Y}_{Q}}{{Y}_{E} - {Y}_{P}} = \frac{{X}_{QL} - {X}_{QR}}{{X}_{ER} - {X}_{EL}} \\ Therefore , \\ {Y}_{P} = \frac{{Y}_{E} ( {X}_{QL} - {X}_{QR} ) + {Y}_{Q} ( {X}_{ER} - {X}_{EL} )}{( {X}_{ER} - {X}_{EL} ) + ( {X}_{QL} - {X}_{QR} )} \qquad Eq . ( 19 )$$

From Eq. (13), (16) and (19), the 3D real world coordinate of an object can be calculated by the screen coordinate of the object in the left and right view, and the position of the user's left and right eye.

As described above, the determination of the degree of response of an object is based on the distance of the clicking point to the camera d, the distance of the clicking point to the object c and the size of the object s.

The distance of the clicking point to an object c can be calculated by the coordinates of the clicking point and the object in the 3D real world coordinate system. Suppose that the coordinates of the clicking point in the 3D real world coordinate system is (X₁, Y₁, Z₁), which is calculated by the 2D image coordinates of the clicking point in the left and right images, and the coordinates of an object in the 3D real world coordinate system is (X₂, Y₂, Z₂), which is calculated by the screen coordinates of the object in the left and right views as well as the 3D real world coordinates of the user's left and right eyes. The distance of the clicking point (X₁, Y₁, Z₁) to the object (X₂, Y₂, Z₂) can be calculated as:

c=\sqrt{(x₁−x₂)²+(y₁−y₂)²+(z₁−z₂)²} Eq. (20)

The distance of the clicking point to the camera d is the value of Z coordinates of the clicking point in the 3D real world coordinate system, which can be calculated by the 2D image coordinates of the clicking point in the left and right images. As illustrated in FIG. 4, axis X of the 3D real world coordinate system is just the line connecting the two cameras and the origin is the center of the line. Therefore, the X-Y planes of the two camera coordinate systems overlap the X-Y plane of the 3D real world coordinate system. As a result, the distance of the clicking point to the X-Y plane of any camera coordinate system is the value of Z coordinates of the clicking point in the 3D real world coordinate system. It should be noted that the precise definition of “d” is “the distance of the clicking point to the X-Y plane of the 3D real world coordinate system” or “the distance of the clicking point to the X-Y plane of any camera coordinate system.” Suppose that the coordinates of the clicking point in the 3D real world coordinate system is (X₁, Y₁, Z₁), since the value of Z coordinates of the clicking point in the 3D real world coordinate system is Z₁, the distance of the clicking point (X₁, Y₁, Z₁) to the camera can be calculated as:

d=Z₁ Eq. (21)

The size of the object s can be calculated once the 3D real world coordinates of the object are calculated. In computer graphics, a bounding box is the closed box with the smallest measure (area, volume, or hyper-volume in higher dimensions) that completely contains the object.

In this invention, the object size is a common definition of the measurement of the object's bounding box. In most cases “s” is defined as the largest one of the length, width and height of the bounding box of the object.

A probability value of response that an object should respond to the user's clicking gesture is defined on the basis of the above-mentioned distance of the clicking point to the camera d, the distance of the clicking point to the object c and the size of the object s. The general principle is that the farther the clicking point is from the camera, or the closer the clicking point is to the object, or the smaller the object is, the larger the responding probability of the object. If the clicking point is in the volume of an object, the response probability of this object is 1 and this object will definitely respond to the clicking gesture.

To illustrate the computation of the responding probability, the probability with respect to the distance of the clicking point to the camera d can be computed as:

$$P ( d ) = \{ \begin{matrix}exp ( - \frac{{a}_{3}}{{a}_{1} - {a}_{2}} ) & d \leq {a}_{1} \\ exp ( - \frac{{a}_{3}}{d - {a}_{2}} ) & d > {a}_{1}\end{matrix} \qquad Eq . ( 22 )$$

And the probability with respect to the distance of the clicking point to the object c can be computed as:

$$P ( c ) = \{ \begin{matrix}0 & c > {a}_{5} \\ exp ( - {a}_{4} c ) & c \leq {a}_{5}\end{matrix} \qquad Eq . ( 23 )$$

And the probability with respect to the size of the object s can be computed as:

$$P ( s ) = \{ \begin{matrix}{a}_{6} & s > {a}_{8} \\ exp ( - {a}_{7} s ) & s \leq {a}_{8}\end{matrix} \qquad Eq . ( 24 )$$

The final responding probability is the production of above three possibilities.

P=P(d)P(c)P(s)

Here a₁, a₂, a₃, a₄, a₅, a₆, a₇, a₈ are constant values. The following is embodiments regarding a₁, a₂, a₃, a₄, a₅, a₆, a₇, a₈.

It should be noted that the parameters depend on the type of display device, which itself has an influence on the average distance between the screen and the user. For example, if the display device is a TV system, the average distance between the screen and the user becomes longer than that in a computer system or a portable game system.

For P(d), the principle is that the farther the clicking point is from the camera, the larger the responding probability of the object is. The largest probability is 1. The user can easily click on the object when the object is near his eyes. For a specific object, the nearer the user is from the camera, the nearer the object is from his eyes. Therefore, if the user is near enough to the camera but he doesn't click on the object, he does very likely not want to click the object. Thus when d is less than a specific value, and the system detects that he doesn't click on the object, the responding probability of this object will be very little.

For example, in a TV system, the system can be designed such that the responding probability P(d)will be 0.1 when d is 1 meter or less and 0.99 when d is 8 meter. That is, a₁=1, and

when d=1,

a₁=1, and

when d=1,

$$exp ( - \frac{{a}_{3}}{1 - {a}_{2}} ) = 0.1 ,$$

and
when d=8,

$$exp ( - \frac{{a}_{3}}{8 - {a}_{2}} ) = 0.99$$

By this two equations, a₂ and a₃ are calculated as a₂=0.9693 and a₃=0.0707.

However, in a computer system, the user will be closer to the screen. Therefore, the system may be designed such that the responding probability P(d)will be 0.1 when d is 20 centimeter or less and 0.99 when d is 2 meter. That is, a₁=0.2, and

when d=0.2,

$$exp ( - \frac{{a}_{3}}{0.2 - {a}_{2}} ) = 0.1 ,$$

and
when d=2

$$exp ( - \frac{{a}_{3}}{2 - {a}_{2}} ) = 0.99$$

Then a₂ and a₃ are calculated as a₁=0.2, a₂=0.1921 and a₃=0.0182.

For P(c), the responding probability should be close to 0.01 if the user clicks at a position 2 centimeters away from the object. Then the system can be designed such that the responding probability P(c) is 0.01 when c is 2 centimeters or greater. That is,

a₅=0.02, and

exp(−a₄×0.02)=0.01

Then a₅ and a₄ are calculated as a₅=0.02 and a₄=230.2585.

Similarly, for P(s), the system can be designed such that the responding probability P(s) is 0.01 when the size of the object s is 5 centimeters or greater. That is

a₆=0.01, and
when a₈=0.05,

exp(−a₇×0.05)=0.01

Then a₆, a₇, and a₈ are calculated as a₆=0.01, a₇=92.1034 and a₈=0.05.

In this embodiment, when a clicking operation is detected, the responding probability of all objects will be computed. The object with the greatest responding probability will respond to the user's clicking operation.

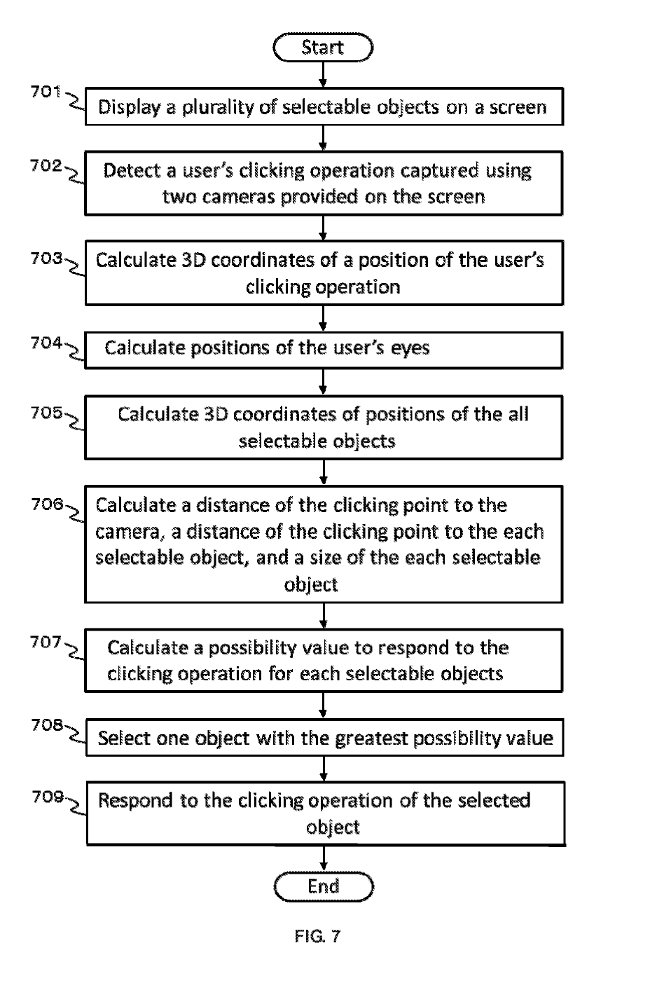

FIG. 7 is a flow chart showing a method responding to a user's clicking operation in the 3D real world coordinate system according to an embodiment of the present invention. The method is described below with reference to FIGS. 1, 4, 5, and 6.

At step 701, a plurality of selectable objects are displayed on a screen. A user can recognize each of the selectable objects in the 3D real world coordinate system with or without glasses, e.g. as shown FIG. 1. Then the user clicks one of the selectable objects in order to implement a task the user wants to do.

At step 702, the user's clicking operation is captured using the two cameras provided on the screen and converted into a video signal. Then the computer 13 processes the video signal using any software programmed in order to detect and identify the user's clicking operation.

At step 703, the computer 13 calculates 3D coordinates of the position of the user's clicking operation as shown in FIG. 4. The coordinates are calculated according to 2D image coordinates of the scene point in the left and right images.

At step 704, the 3D coordinates of the user's eye positions are calculated by the computer 13 shown as FIG. 4. The positions of the user's eyes are detected by the two cameras 10 and 11. The video signal generated by the cameras 10 and 11 captures the user's eye position. The 3D coordinates are calculated according to the 2D image coordinates of the scene point in the left and right images.

At step 705, the computer 13 calculates 3D coordinates of positions of the all selectable objects on the screen dependent on the positions of the user's eyes as shown FIG. 6.

At step 706, the computer calculates a distance of the clicking point to the camera, a distance of the clicking point to the each selectable object, and a size of the each selectable object.

At step 707, the computer 13 calculates a probability value to respond to the clicking operation for each selectable object using the distance of the clicking point to the camera, the distance of the clicking point to the each selectable object, and the size of the each selectable object.

At step 708, the computer 13 selects an object with the greatest probability value.

At step 709, the computer 13 responds to the clicking operation of the selected object with the greatest probability value. Therefore, even if the user does not click an object which he/she wants to click exactly, the object may respond to the user's clicking operation.

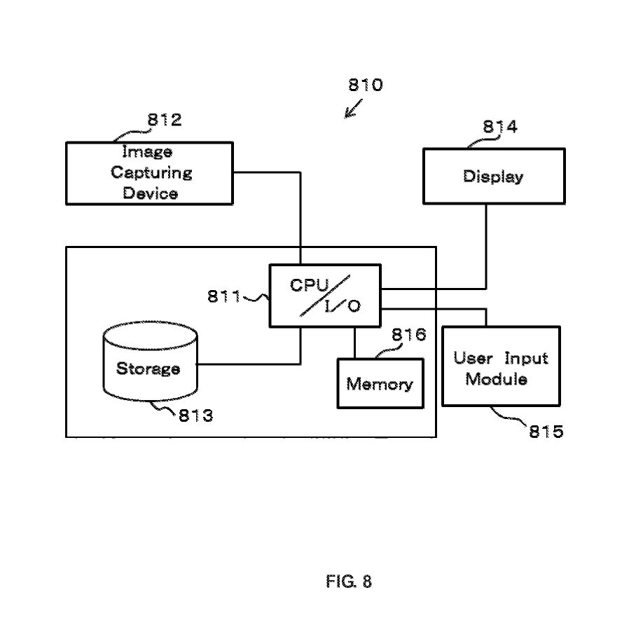

FIG. 8 illustrates an exemplary block diagram of a system 810 according to an embodiment of the present invention.

The system 810 can be a 3D TV set, computer system, tablet, portable game, smart-phone, and so on. The system 810 comprises a CPU (Central Processing Unit) 811, an image capturing device 812, a storage 813, a display 814, and a user input module 815. A memory 816 such as RAM (Random Access Memory) may be connected to the CPU 811 as shown in FIG. 8.

The image capturing device 812 is an element for capturing user's clicking operation. Then the CPU 811 processes video signal of the user's clicking operation to detect and identify the user's clicking operation. The Image capture device 812 also captures user's eyes, and then the CPU 811 calculates the positions of the user's eyes.

The display 814 is configured to visually present text, image, video and any other contents to a user of the system 810. The display 814 can apply any types which is adapted to 3D contents.

The storage 813 is configured to store software programs and data for the CPU 811 to drive and operate the image capturing device 812 and to process detections and calculations as explained above.

The user input module 815 may include keys or buttons to input characters or commands and also comprise a function to recognize the characters or commands input with the keys or buttons. The user input module 815 can be omitted in the system depending on use application of the system.

According to an embodiment of the invention, the system is fault-tolerant. Even if a user doesn't click on an object exactly, the object may respond the clicking if the clicking point is near the object, the object is very small, and/or the clicking point is far away from the cameras.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1-10. (canceled)

11. A method for responding to a user's gesture to an object in three dimensions, wherein at least one object is displayed on a display device, the method including:
detecting a gesture of a user's hand captured using an image capturing device;
calculating 3D coordinates of the position of the gesture and the user's eyes;
calculating 3D coordinates of positions of the at least one object as a function of the positions of the user's eyes;
calculating a distance of the position of the gesture to the image capturing device, a distance of the position of the gesture to the each object, and a size of the each object;
calculating a probability value to respond to the gesture for each accessible object using the distance of the position of the gesture to the image capture device, the distance of the position of the gesture to the each object, and the size of the each object;
selecting one object with the greatest probability value; and
responding to the gesture of the one object.

12. The method according to claim 11, wherein the image capture device comprises of two cameras aligned horizontally and having the same focal length.

13. The method according to claim 12, wherein the 3D coordinates are calculated on the basis of 2D coordinates of left and right images of the selection gesture, the focal length of the cameras, and a distance between the cameras.

14. The method according to claim 13, wherein 3D coordinates of positions of the object are calculated on the basis of 3D coordinates of the positions of the user's right and left eyes and 3D coordinates of the object in right and left views.

15. A system for responding to a user's gesture to an object in three dimensions, wherein at least one object is displayed on a display device, the system comprising a processor configured to implement:
detecting a gesture of a user's hand captured using an image capturing device;
calculating 3D coordinates of the position of the gesture and the user's eyes;
calculating a distance of the position of the gesture to the image capturing device, a distance of the position of the gesture to the each object, and a size of the each object;
calculating a probability value to respond to the gesture for each accessible object using the distance of the position of the gesture to the image capture device, the distance of the position of the gesture to the each object, and the size of the each object;
selecting one object with the greatest probability value; and
responding to the gesture of the one object.

16. The system according to claim 15, wherein the image capture device comprises of two cameras aligned horizontally and having the same focal length.

17. The system according to claim 16, wherein the 3D coordinates are calculated on the basis of 2D coordinates of left and right images of the selection gesture, the focal length of the cameras, and a distance between the cameras.

18. The system according to claim 7, wherein 3D coordinates of positions of the objects are calculated on the basis of 3D coordinates of the positions of the user's right and left eyes and 3D coordinates of the object in right and left views.
